(19) United States
(12) Patent Application Publication
(10) Pub. No.: US 2022/0183407 A1
(43) Pub. Date: Jun. 16, 2022

(54) DISPOSABLE MASK

(71) Applicant: UNIQLOOP HONG KONG LIMITED, Hong Kong (CN)

(72) Inventor: Kin Zheng, Hong Kong (CN)

(21) Appl. No.: 17/118,575

(22) Filed: Dec. 10, 2020

(51) Int. Cl. A41D 13/11

(52) U.S. Cl. CPC A41D 13/1161; A41D 13/1115

(57) ABSTRACT

The present invention discloses a disposable mask comprising a filter body including a base and at least one connecting part fixed to the base, and at least one detachable decorative strap connected to the filter body. The present invention brings users both functionality and aesthetics.

### FIELD OF THE PRESENT DISCLOSURE

The present invention relates generally to a mask. More particularly, this invention relates to a disposable mask.

### DESCRIPTION OF RELATED ART

In recent years, as air quality has decreased, masks have become necessaries in human daily life. Masks could be used to prevent not only the dust in air but also bacteria and viruses.

In the prior art, it has been disclosed a mask including a filter body and a pair of flexible ear loops fixed to the filter body in a method of hot melting. Despite the flexibility of the ear loop, the length of the ear loops cannot be adjusted freely. Therefore, it can only meet needs of a small range of users who have different face sizes. The pair of the ear loops may have a big pressure on ears, which makes the users feel uncomfortable.

Therefore, it is necessary to provide a new disposable mask for solving above mentioned problem.

### SUMMARY

In one aspect of the present disclosure, a disposable mask comprises a filter body including a base and at least one connecting part fixed to the base, and at least one detachable decorative strap connected to the filter body.

### BRIEF DESCRIPTION OF THE DRAWINGS

FIG. 1 is a perspective view illustrating a disposable mask according to a first embodiment of the present disclosure.

FIG. 2 is a schematically cross-sectional view of the disposable mask shown in FIG. 1.

FIG. 3 is a perspective view illustrating a filter body of the disposable mask shown in FIG. 1.

FIG. 4 is a perspective view illustrating a disposable mask according to a second embodiment of the present disclosure.

FIG. 5 is a perspective view illustrating a disposable mask according to a third embodiment of the present disclosure.

FIG. 6 is a perspective view illustrating a disposable mask according to a fourth embodiment of the present disclosure.

### DETAILED DESCRIPTION OF THE EXEMPLARY EMBODIMENTS

Hereinafter, the present disclosure will be further described with reference to the accompanying drawings and embodiments.

### Embodiment 1

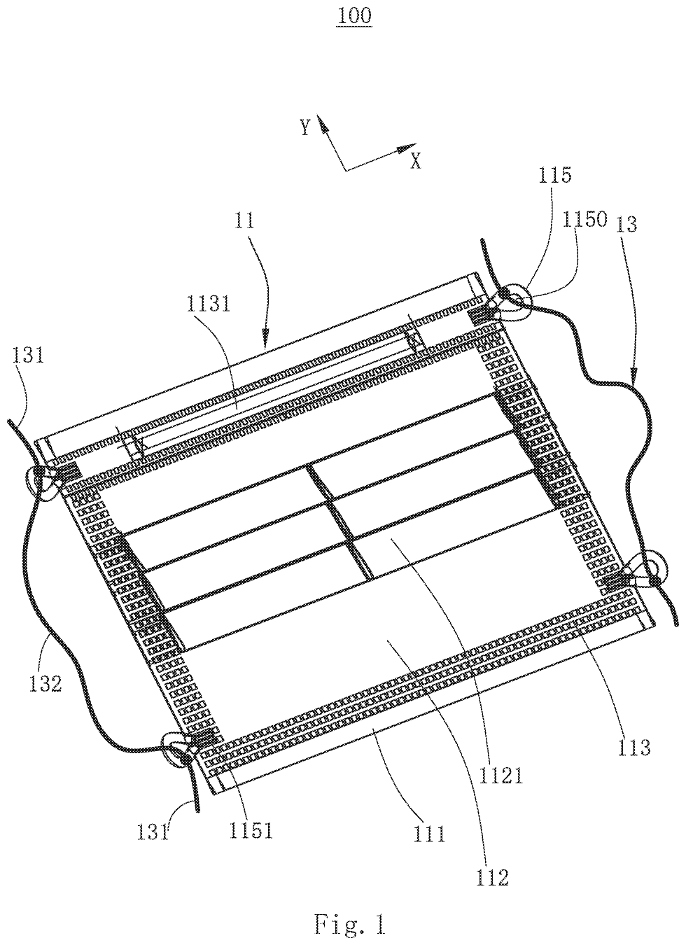

As shown in FIG. 1, a disposable mask 100 in the present invention includes a filter body 11 and at least one detachable decorative strap 13 connected to the filter body 11. In this embodiment, the number of the detachable decorative straps 13 is two. The two detachable decorative straps 13 can be hung on some part of the user's body, such as the ears, head, neck, et cetera.

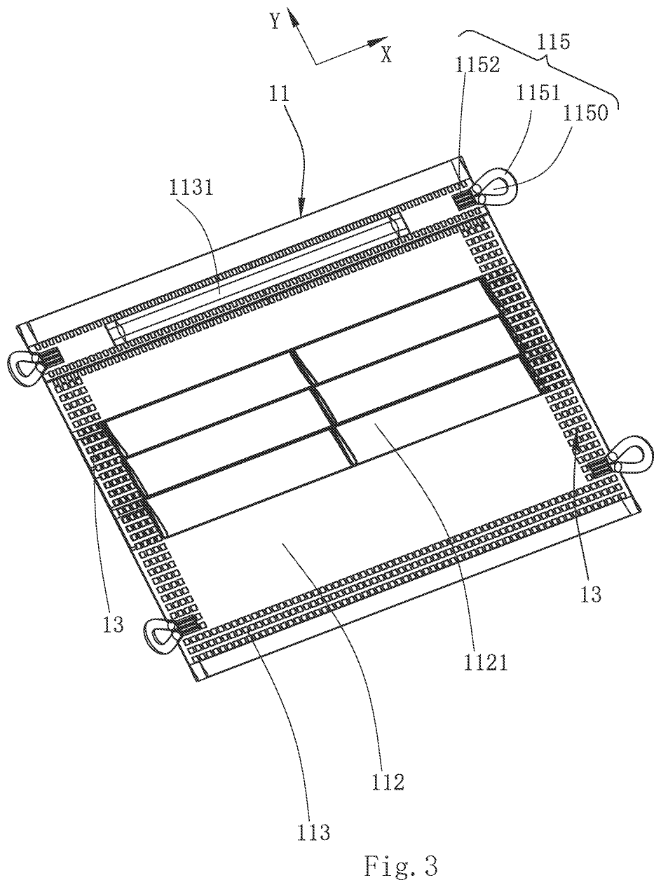

As shown in FIG. 3, the filter body 11 includes a base 111 having a rectangular configuration. The base 111 has two long sides extending along a first direction X, and two short sides extending along a second direction Y. The first direction X is perpendicular to the second direction Y. The base 111 includes a main portion 112 having a multi-layer structure and a fixed portion 113 surrounding the main portion 112. The fixed portion 113 is formed by hot melting the main portion 112.

The filter body 11 further includes a plurality of connecting parts 115 fixed to the base 111. In this embodiment, the number of the plurality of connecting parts 115 is four. Each connecting part 115 includes a ring part 1151 forming a hole 1150 and two ends 1152 fixed to the fixed portion 113 of the base 111. The four connecting parts 115 are separately fixed to four corners of the base 111. The two ends 1152 of each connecting part 115 are fixed to the base 111 in a method of hot melting or fusion welding.

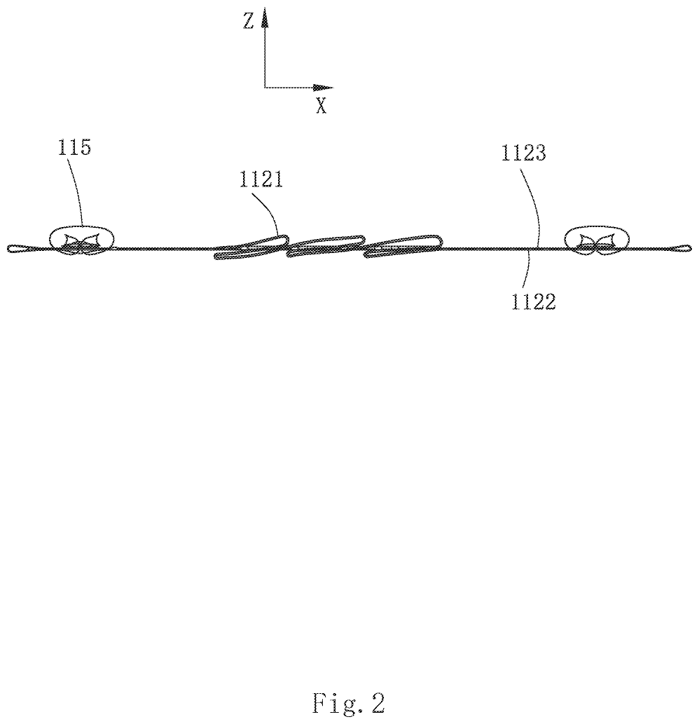

As shown in FIGS. 2 and 3, the base 111 further includes a plurality of folded parts 1121 disposed at the main portion 112 and a metal bar 1131 disposed at the fixed portion 113. The folded parts 1121 can be expanded while being used so that a three-dimensional mask that can provide a bigger protecting area and a more comfortable breathing space is obtained. The adjacent two folded parts 1121 are partially overlapped along a third direction Z. The metal bar 1131 can be bended to fit for the user's nose while being used.

As shown in FIG. 3, a thickness of the base 111 along the third direction Z is smaller than a thickness of each folded part 1121 along the third direction Z. The direction Z is perpendicular to both the first direction X and the second direction Y.

The base 111 may be made of a single material or a stacked combination of materials by a method of hot melting. The materials may include non-woven fabric, anti-bacterial filter paper, activated carbon cloth, waterproof breathable film, non-woven coating material. The porous structure formed by multi-layer fabrics achieves an effective adsorption of the dust and various germs.

The main portion 112 of the base 111 includes an outer layer 1122, an inner layer 1123 close to the user's skin and a middle layer disposed between the outer layer 1122 and the inner layer 1123. Each of the outer layer 1122, the middle layer and the inner layer 1123 could be made of polypropylene microfibers or polypropylene melt-blown fabric. Activated carbon, activated carbon fiber and other materials having ultra-high adsorption properties can also be added into each of the outer layer 1122, the middle layer and the inner layer 1123 to increase the filterability of the disposable mask 100.

The four connecting parts 115 can be fixed to either the inner layer 1123 or the outer layer 1122. The four connecting parts 115 are made of elastic material.

As shown in FIG. 1, each detachable decorative strap 13 includes a hanging portion 132 used for hanging on the user's ear and two free ends 131 respectively knotted at the ring parts 1151 after passing through the holes 1150 of the connecting parts 115. The length of the hanging portion 132 can be adjusted by changing the knotted position of the two free ends 131. Therefore, the disposable mask 100 can be suitable for various users having different face sizes. The detachable decorative strap 13 can be made of elastic material or colorful braided rope alternatively decorated with accessories, which brings users both functionality and aesthetics.

### Embodiment 2

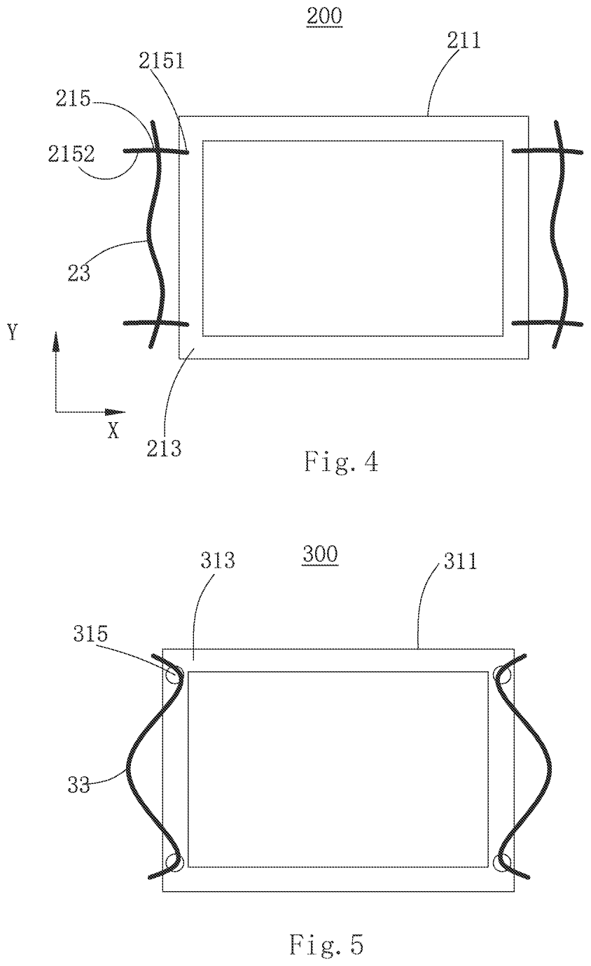

In this embodiment, as shown in FIG. 4, most of the elements of disposable mask 200 are the same as that in EMBODIMENT 1. Only one difference presented in EMBODIMENT 2 is detailed as follows. Each of the plurality of connecting part 215 includes a first end 2151 fixed to the fixed portion 213 of the base 211 and a second end 2152 connecting with the decorative straps 23. The second end 2152 is a free end. In this embodiment, the number of the plurality of connecting parts 215 is four. The four connecting parts 215 are separately fixed to four corners of the base 211. The first end 2151 of each connecting part 215 is fixed to the base 211 in a method of hot melting or fusion welding. The detachable decorative strap 23 could be fixed to the second end 2152 of the connecting part 215 in a method of knotting.

### Embodiment 3

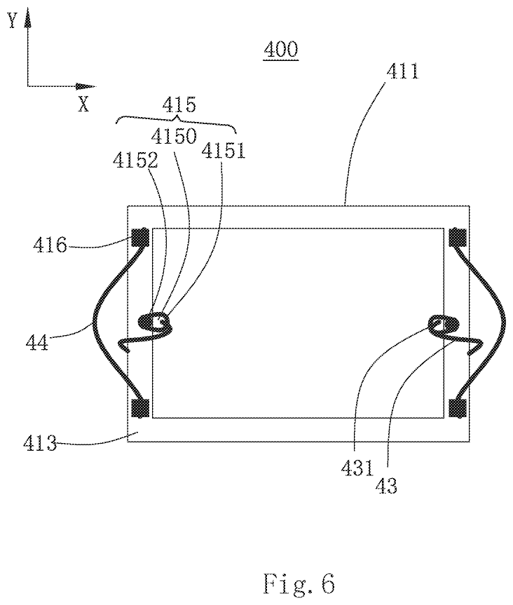

In this embodiment, as shown in FIG. 5, most of the elements of disposable mask 300 are the same as that in EMBODIMENT 1. Only one difference presented in EMBODIMENT 3 is detailed as follows. Each of the plurality of connecting parts 315 is a hole formed at the fixed portion 313. In this embodiment, the number of the plurality of connecting parts 315 is four. The four connecting parts 315 are separately formed at four corners of the base 311. The detachable decorative strap 33 could be fixed to the connecting part 315 in a method of knotting after passing through the hole.

### Embodiment 4

In this embodiment, as shown in FIG. 6, most of the elements of disposable mask 400 are the same as that in EMBODIMENT 1. Only one difference presented in EMBODIMENT 4 is detailed as follows. The number of the plurality of connecting parts 415 is two. The two connecting parts 415 are respectively disposed at the two short sides of the base 411. Each connecting part 415 is disposed at the center of one of the two short sides. Each connecting part 415 includes a ring part 4151 forming a hole 4150 and two ends 4152 fixed to the fixed portion 413 of the base 411. The connecting part 415 is made of elastic rope.

The filter body 41 further includes four fixed parts 416 disposed at four corners of the base 411 and a pair of elastic straps 44 fixed to the four fixed parts 416 in a method of hot melting or fusion welding. The detachable decorative strap 43 includes a first end 431 connected to the ring part 4151 in a method of knotting after passing through the hole 4152. The number of the detachable decorative strap 43 could be one or two more, which is not limited.

The above is only the embodiment of the present invention, but not limit to the patent scope of the present disclosure, and the equivalent structures or equivalent process transformations made by utilizing the present disclosure and the contents of the drawings, or directly or indirectly applied to other related technology fields, are all included in the scope of the patent protection of the present disclosure.

What is claimed is:

1. A disposable mask, comprising;
a filter body including a base and at least one connecting part fixed to the base;
at least one decorative strap detachably connected to the connecting part.

2. The disposable mask according to claim 1, wherein the base has a main portion having a multi-layer structure and a fixed portion surrounding the main portion, each of the at least one connecting part is disposed at the fixed portion.

3. The disposable mask according to claim 2, wherein the disposable mask has four connecting parts, the four connecting parts are separately fixed to four corners of the base.

4. The disposable mask according to claim 3, wherein the decorative strap has a hanging portion and two free ends, the connecting part has a ring part forming a hole, each of the two free ends is knotted at the ring part.

5. The disposable mask according to claim 4, wherein the ring part is formed by a ring-shaped elastic rope with two ends thereof fixed to the fixed portion of the base via hot melting.

6. The disposable mask according to claim 2, wherein each of the at least one connecting part is a hole formed at the fixed portion of the base.

7. The disposable mask according to claim 6, wherein, the decorative strap has a hanging portion and two free ends, each of the two free ends is knotted at the hole.

8. The disposable mask according to claim 7, wherein each of the at least one connecting part includes a first end fixed to the fixed portion of the base and a second end connecting with one of the two free ends.

9. The disposable mask according to claim 8, wherein the first end is fixed to the base in a method of hot melting or fusion welding.

10. The disposable mask according to claim 9, wherein each of the two free ends is knotted with the second end.

11. The disposable mask according to claim 2, wherein the base has a rectangular shape and includes two long sides and two short sides.

12. The disposable mask according to claim 11, wherein the connecting part has a ring part forming a hole.

13. The disposable mask according to claim 12, wherein the number of the at least one connecting part is two, the two connecting parts are separately fixed to the two short sides of the base.

14. The disposable mask according to claim 13, wherein each of the two connecting parts is disposed at the center of each of the two short sides of the base.

15. The disposable mask according to claim 14, wherein the number of the at least one decorative strap is two, and the two decorative straps are made of colorful braided rope.

16. The disposable mask according to claim 15, wherein each decorative strap includes a first end connected to the ring part in a method of knotting after passing through the hole.

17. The disposable mask according to claim 16, wherein the main portion includes an outer layer, an inner layer and a middle layer disposed therebetween.

18. The disposable mask according to claim 17, wherein the base has a plurality of folded parts disposed at the main portion and a metal bar disposed at the fixed portion.
